(19) United States
(12) Patent Application Publication
(10) Pub. No.: US 2002/0017979 A1
(43) Pub. Date: Feb. 14, 2002

(54) Method of the transmission of data

(76) Inventors: Jens Krause, Rahden (DE); Uwe Metzing, Stemwede (DE)

Correspondence Address: Daniel C. McEachran, Cook, Alex, McFarron, Manzo,, Cummings & Mehler, Ltd., 200 West Adams Street - Suite 2850, Chicago, IL, 60606, US

(21) Appl. No.: 09/757,927

(22) Filed: Jan. 10, 2001

(30) Foreign Application Priority Data
Jan. 11, 2000 (DE) 100 00 756.2

(51) Int. Cl. H04Q 5/22; G08G 1/09; G08G 1/00; G08G 1/065

(52) U.S. Cl. 340/10.1; 340/10.34; 340/905; 340/928

(57) ABSTRACT

The invention relates to a method for transmitting data between a transponder which is incorporated in a vehicle and an inquiry station, said transponder being applied by an energy storage of its own which is charged by a charging station via wireless energy transmission. In this method the transponder first passes the transmission range of the charging station whereby the energy storage is being charged, then the transponder reaches the transmission range of the inquiry station causing the inquiry station to send a request signal on a first frequency which is received by the transponder. The transponder then sends the requested data on a second frequency. Since the vehicle passes the transmission range of the inquiry station first, the energy storage of the transponder can be charged during the whole time in which the vehicle resides within this transmission range. After the charge of the energy storage, the transponder can send on a second frequency, which may be higher in order to cope with a larger amount of data, when it resides within the transmission range of the inquiry station with no need for the term of transmission to be reduced on account of charging.

The invention relates to a method for the transmission of data between a transponder incorporated in a vehicle and an inquiry station, said transponder being supplied by an energy storage of its own which is charged by a charging station via wireless energy transmission.

The invention relates further to a transponder for employment in the afore-mentioned method as well as to a transmitter/receiver system for transmitting data between a transponder incorporated in a vehicle and an inquiry station, the transponder being supplied by an energy storage of its own which is charged by a charging station via wireless energy transmission.

Various methods of this kind are already known. For example, in DE 40 02 801 C1 a generic method is disclosed in which a high frequency inquiry impulse is sent to a transponder which in return sends its identification and/or measurement data back to the inquiry device. With this, the energy of the high frequency inquiry impulse is used for charging an energy storage in the embodiment of a capacitor. The energy stored in the capacitor serves as supply for the transponder. The disadvantage of this method is that the energy transmitted by the high frequency inquiry impulse is very low. With it, the transponder can only be operated for a very short time. Therefore, the amount of data which can be transmitted is strongly limited. However, with the employment of data transmission methods in vehicle identification systems, nowadays a considerable amount of data is to be transmitted. Further, this amount of data is to be transmitted as fast as possible, because the vehicle should not leave the range of the transmitter before the data transmission is completed. For the same reason, the duration of the inquiry impulse cannot be increased in order to stretch the charging time. In addition, it would be appreciated to have more energy for collecting, processing and storing of the data in the transponder.

The aim of the invention is to improve the method mentioned in the beginning in a way that the amount of energy stored within the energy storage of the transponder and the data transmission rate are increased.

This is achieved in a generic method by the transponder passing the transmission range of the charging station first, whereby the energy storage is being charged, then the transponder reaching the transmission range of the inquiry station, causing the inquiry station to send a request signal on a first frequency which is received by the transponder and then the transponder sending the requested data on a second frequency. Since the vehicle passes the transmission range of the charging station first, the energy storage of the transponder may be charged during the whole time in which the vehicle resides within this transmission range. After charging of the energy storage the transponder can send, when being located within the transmission range of the inquiry station, on a second frequency which may be higher in order to cope with a greater amount of data, without the need to reduce the term for transmission on account of charging.

According to an advantageous embodiment of the invention the position of the transponder with respect to the inquiry station is being registered and the request signal is sent only when the transponder is in a position with respect to the inquiry station which is optimal for the data transmission. With this, the range and as a result the transmission power of the transponder can be minimized, which is on one hand decreasing the consumption of energy of the transponder and on the other hand is an advantage regarding aspects of care for the environment (electronic radiation).

Another embodiment of the invention provides that the request signal from the transponder is being evaluated whether a first or a second group of data is to be sent. In this way, the inquiry station can control which data it will obtain.

According to yet another embodiment of the invention it is provided that the requesting signal from the transponder is being evaluated whether the transponder should receive and store data from the inquiry station. With this, it is possible to program the transponder from the inquiry station or to change the programming.

Another advantageous embodiment of the invention provides that the evaluation of the request signal depends on the charging conditions of the energy storage of the transponder. This prevents data from being transmitted incompletely if the energy remaining in the energy storage is not sufficient for a complete data transmission.

The invention further provides a transponder for employment in the above-mentioned method, comprising a receiver for a first frequency and a transmitter for a second frequency and comprising an energy storage supplying the transponder and being connected to an antenna.

The invention further provides a transmitter/receiver system for the data transmission method according to the invention, in which the charging station is separated spatially from the inquiry station.

Further advantages of the invention result from the following specification of the preferred embodiment of the invention, referring to the accompanying drawings, in which:

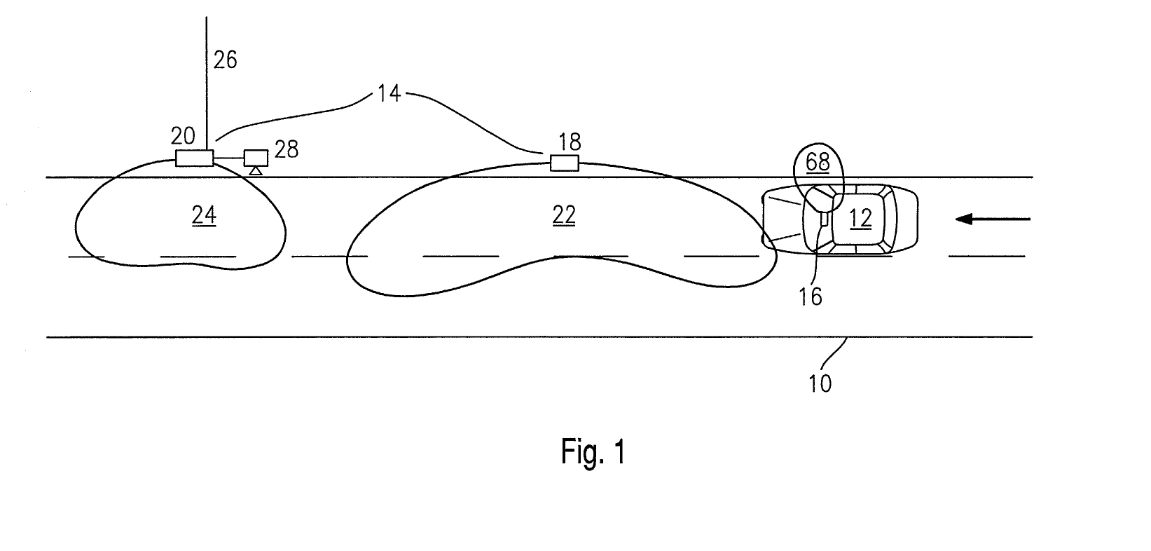

FIG. 1 shows a schematic view of an arrangement for implementation of the method according to the invention;

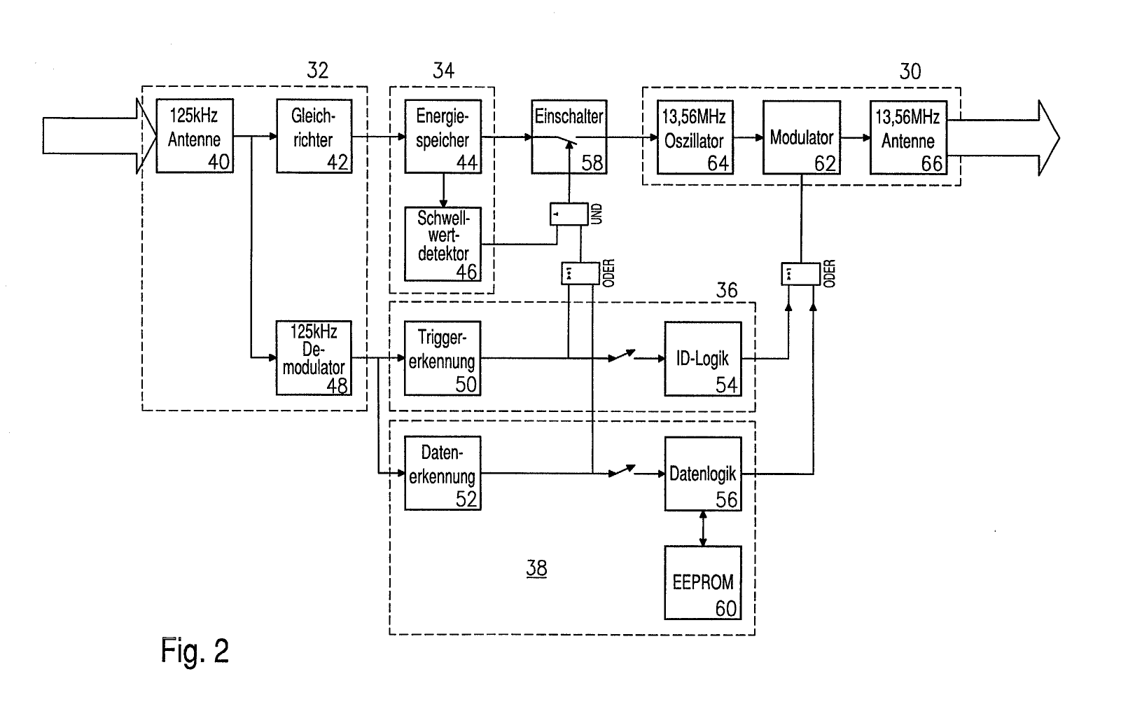

FIG. 2 shows a block diagram of an embodiment of a transponder according to the invention.

In FIG. 1 an arrangement for carrying out the method according to the invention can be seen. To this aim a transmitter/receiver system 14 is arranged on a street 10 on which vehicles 12 move. In this exemplary embodiment, data is to be transmitted from vehicles having incorporated a transponder 16 and driving on the street 10 in a direction indicated by the arrow. The transmitter/receiver system 14 consists of a charging station 18 and an inquiry station 20. The charging station 18 is sending without modulation on a frequency of 125 kHz. By the area 22 is indicated a range in which a definite minimum field intensity is guaranteed. The charging station 18 may be of a constitution in which it emits directed to the drive way. The charging station 18 may be either stationary or mobile, so it can be used in another place, if necessary. The energy supply for the charging station 18 may be provided by the local mains supply. This solution is obvious for a stationary charging station. However, an autark energy supply, for instance by battery and/or solar cells may be considered, which is advantageous especially with several charging stations or upon installation outside of town.

The inquiry station 20 comprises a modulatable transmitter for the same frequency (125 kHz) as the charging station. The range of guaranteed minimum field intensity indicated by the area 24 may be smaller than the range 22 of the charging station, because less time is necessary for sending the inquiry command than for charging. Like the charging station 18, the inquiry station 20 as well may emit directed. The inquiry station 20 is controlled by a central (not shown) to which it is connected via a line 26. The inquiry station 20 may be supplied via this line 26 with energy also, but the possibilities described for the charging station 18 may be applied as well. Instead of the line 26 to the central, a radio link may be considered. In this case the inquiry station can be used mobile instead of stationary, as described in context with the charging station 18. The inquiry station 20 may work stand-alone as well, if it is controlled by an incorporated microprocessor writing the collected data into a mass storage device which is changed or interrogated, if necessary. These techniques are well-known to the man skilled in the art and will thus be not further described. The inquiry station 20 further comprises a receiver for a frequency of 13.56 MHz. Connected to the inquiry station 20 is a position sensor 28, detecting the exact position of the vehicle 12 when it is located within the vicinity and passing this position to the inquiry station 20.

Arranged in the vehicle 12 is a transponder 16. The design of said transponder is shown in detail in the block diagram in FIG. 2. The transponder 16 consists of the functional units transmitter 30, receiver 32, energy store 34, trigger logic 36 and data control logic 38. The separate components of the functional units which are combined in FIG. 2 by dashed lines, result from the following description of function.

If the vehicle passes the transmitter/receiver system 14 as indicated in FIG. 1 by the arrow, it passes the transmission range 22 of the charging station 18 first. With this, the antenna 40 of the receiver 32 in the transponder 16 receives the unmodulated 125 kHz signal of the charging station 18. This signal is rectified by the rectifier 42 into a DC voltage for charging an energy storage 44 assigned to the transponder. The transmission range 22 of the charging station has to be designed large enough, so the time that is necessary for the vehicle 12 to cross the sending range 22 is long enough to charge the energy storage 44 if the vehicle is driving with a medium velocity. If the energy storage 44 has been charged sufficiently, the threshold detector 46 will provide a strobe on its output.

In the following the vehicle 12 approaches the inquiry station 20. As soon as the position sensor 28 detects that the vehicle 12 is in an optimal position for the data transmission, the inquiry station 20 sends a trigger code as a request signal on the request frequency. One criterium for the optimal position for the data transmission may be for instance the orientation of the antennae of transmitter and receiver with respect to each other. According to demand, different trigger codes may be sent. One trigger code may contain only the inquiry code for the identification of the transponder for instance, another may contain a command to read data stored within the transponder or to store data which is being sent together with the command. The trigger code is received by the antenna 40, demodulated within the demodulator 48 and passed to the trigger recognition 50 and the data recognition 52, respectively. The trigger and data recognition 50, 52 detects which command was sent and controls the performance of the corresponding command via the identification logic 52 and the data logic 56, respectively. If the command contains an instruction to send the identification and/or data, then the sender 30 is started via the switch 58 if the release signal on the output of the threshold detector 46 ensures that the energy storage is charged sufficiently. If the command contains an instruction for reading or storing of data, then the data logic 56 reads this data from the EEPROM 60 or writes the received data into the EEPROM 60, respectively. The data or an identification code to be sent will be passed by the data logic 56 or the identification logic 54, respectively, to the modulator 62 which modulates the frequency of 13.56 MHz supplied by the oscillator 64 and broadcasts it over the antenna 66. This broadcast is received by the receiver in the inquiry station 20 and the enclosed information is passed via the line 26 to the central. Since the broadcast is performed with a very high transmission frequency of 13.56 MHz, the necessary amount of data can be transmitted within a shortest period of time, at least in relation to the charging time of the energy storage 44, while the vehicle 12 practically does not change its position during this time. This is why the optimal conditions for data transmission between the transponder 16 and the inquiry station 20 are maintained, affording only a very small range for the transmitter 30, indicated in FIG. 1 by the range 68. This bears the advantage that the transmitter 30 needs only small transmission power and correspondingly a small power consumption, resulting in the energy storage 44 being strained less.

Within the transponder 16, it may be further provided to evaluate the release signal of the threshold detector 46 to a larger extent, in that a limited amount of data is sent, when the energy storage 44 is only weakly charged. For example, if an inquiry command requests the reading of the EEPROM 60 and the amount of energy remaining in the energy storage 44 is not sufficient for reading the EEPROM, only the identification code of the transponder may be sent. Especially writing the EEPROM 60 requires a lot of energy. If the transponder 16 receives a command to write data into its EEPROM and the charge is not sufficient, it can advantageously send an error message besides the identification code to the inquiry station. The 125 kHz carrier frequency may also be rectified in the rectifier 42 and may be used additionally for charging the energy storage 44 while the receiver 32 receives the trigger code of the inquiry station 20.

Of course, the invention is not limited to the mentioned frequencies. Other frequencies may be used if the relation between frequency, transmitting power, power consumption of the transmitter, the vehicle velocity and the amount of data to be transmitted is optimized.

The invention can be used in various applications. In the embodiment shown as example, vehicle data for a toll system for calculation of road charging fees may for example be captured. Another application is in a capturing system for parking charges, if for instance upon entering a parking house, the entering time is written into the EEPROM of the transponder which can be read out when leaving the parking house.

Also the arrangement of the transmitter/receiver system 14 in FIG. 1 as well as of the transponder in the vehicle 12 is only an example. An arrangement within the driving way or above on a signal bridge, for instance, is also possible, the transponder 16 within the vehicle being placed accordingly.

It will be emphasized that the application of the invention is in no way limited to road vehicles. The method is also useful with railway vehicles, for example to impose track charges. This application would render special advantages in that the transmission range of the transponder and with it the energy consumption may be extraordinarily small because the position of the vehicle with respect to the transmitter/receiver system crossways to the driving direction is fixed.

1. A method for the transmission of data between a transponder (16) which is incorporated in a vehicle (12) and an inquiry station (20), said transponder being supplied by its own energy storage (44) which is charged by a charging station (18) via wireless energy transmission, characterized by the following steps:
said transponder (16) first passes the transmission range (22) of said charging station (18), whereby said energy storage (44) is being loaded,
said transponder (16) reaches the transmission range (24) of said inquiry station (20),
said inquiry station (20) sends on a first frequency a request signal which is received by said transponder (16), said transponder (16) sends the requested data on a second frequency.

2. The method according to claim 1, characterized in that said charging station (18) is sending in a range of 125 kHz.

3. The method according to claim 2, characterized in that the position of said transponder (16) with respect to said inquiry station (20) is being registered and said request signal is sent only when said transponder is in a position with respect to said inquiry station which is optimal for requesting.

4. The method according to claim 1, characterized in that said request signal from said transponder (16) is being evaluated whether a first or a second group of data is to be sent.

5. The method according to claim 1, characterized in that said request signal from said transponder (16) is being evaluated whether said transponder has to receive and store data from said inquiry station (20).

6. The method according to claim 5, characterized in that the evaluation of said request signal depends on the charging conditions of said energy storage (44) of the transponder (16).

7. The method according to claim 1, characterized in that data is transmitted from said inquiry station (20) to said transponder (16) and stored therein.

8. The method according to claim 1, characterized in that said transponder (16) uses a carrier frequency of about 13.56 MHz for sending.

9. The method according to claim 1, characterized in that the process of charging said energy storage (44) takes much longer than the process of sending said requested data and in that said transponder (16) can be considered as standing still during the process of reading said data.

10. A transponder (16) for employment in a method according to claim 1, comprising a receiver (32) for a first frequency and an emitter (30) for a second frequency and comprising an energy storage (44) supplying said transponder and being connected to an antenna (40).

11. The transponder according to claim 10, characterized in that said transponder (16) comprises an evaluation circuit for evaluation of a request signal sent by said inquiry station (20).

12. The transponder according to claim 11, characterized in that said transponder (16) comprises at least one EEPROM (60), being readable and writeable by said inquiry station (20).

13. A transmitter/receiver system (14) for transmitting data between a transponder (16) which is incorporated in a vehicle (12) and an inquiry station (20), said transponder being supplied by an energy storage (44) of its own which is charged by a charging station (19) via wireless energy transmission, characterized in that said charging station (18) is separated spatially from said inquiry station (20).

14. The transmitter/receiver system according to claim 13, characterized in that a position sensor (28) for detecting the position of said transponder (16) with respect to said inquiry station is assigned to said inquiry station (20).
